(19) United States
(12) Patent Application Publication
(10) Pub. No.: US 2017/0151936 A1
(43) Pub. Date: Jun. 1, 2017

(54) STOP MAINTAINING SYSTEM OF VEHICLE

(71) Applicant: Mazda Motor Corporation, Aki-gun (JP)

(72) Inventors: Masaru Takase, Hiroshima-shi (JP); Shigeyuki Uehara, Hiroshima-shi (JP); Shinya Kyusaka, Higashihiroshima-shi (JP)

(21) Appl. No.: 15/347,570

(22) Filed: Nov. 9, 2016

(30) Foreign Application Priority Data
Nov. 27, 2015 (JP) 2015-232244

(51) Int. Cl. B60T 8/171; B60T 13/74; B60T 8/58; F16H 63/48; B60T 8/24

(52) U.S. Cl. CPC B60T 8/171; F16H 63/48; B60T 8/241; B60T 8/58; B60T 8/245; B60T 13/741

(57) ABSTRACT

A vehicle stop maintaining system comprises a foot brake mechanism for braking vehicle wheels by applying hydraulic brake pressure to hydraulic brake mechanisms according to a depression of a brake pedal, a brake force control mechanism having a pressurizer that increases hydraulic brake pressure to be applied to the hydraulic brake mechanisms, braking the wheels by controlling the pressurizer independently from the depression of the brake pedal, and a controller for executing, when the vehicle is detected to be in a stopped state, a first stop mode in which the brake force control mechanism is operated to maintain the stopped state. The system includes a gear position detector for detecting a position of a gear shift lever of the vehicle. When a vehicle driver intentionally controls the gear shift lever to a reverse position in the first stop mode, the controller cancels the first stop mode.

### BACKGROUND

The present invention relates to a stop maintaining system of a vehicle, which maintains, when the vehicle is detected to be in a stopped state, the stopped state by operating a brake force control device.

Conventional brake devices of vehicles include foot brake devices which brake vehicle wheels by applying hydraulic brake pressure to hydraulic brake mechanisms according to a depression of a brake pedal, brake force control devices which include a pressurizer for increasing hydraulic brake pressure applied to hydraulic brake mechanisms, braking vehicle wheels by controlling the pressurizer independently from depression of a brake pedal, and electric parking brake devices which brake vehicle wheels by operating electric brake mechanisms which are driven by electric actuators independently from a depression of a brake pedal.

Further, when the vehicle is detected to be in a stopped state, the depression of the brake pedal becomes less burdensome for the driver by operating the electric parking brake device.

JP4725180B discloses an automatic braking system including a parking brake device (electric parking brake device) which brakes vehicle wheels by operating electric brake mechanisms which are driven independently from depression of a brake pedal, and a gear position detector for detecting a gear position of a gear shift lever. When a stopped state of a vehicle is detected, the parking brake device is operated to maintain the stopped state, and when the gear position is shifted from a D-range to an R-range, the stopped state is cancelled.

Thus, even when an automatic braking state is cancelled, the stopped state of the vehicle can still be regulated.

JP4039434B discloses a vehicle control system including a brake force control device which includes a pressurizer for increasing hydraulic brake pressure to be applied to hydraulic brake mechanisms, braking vehicle wheels by controlling the pressurizer independently from depression of a brake pedal, and a gear position detector for detecting a gear position of a gear shift lever. When a stopped state of a vehicle is detected, the brake force control device is operated to maintain the stopped state, and when the gear shift lever is controlled by a driver of a vehicle to a drive gear position, a starting speed of the brake force is controlled according to the gear position to which the gear shift lever is controlled.

Thus, a driver can start the vehicle in a state which matches the position of the gear shift lever.

Generally, electric parking brake devices change a rotational motion of the electric actuators into a linear motion by the electric brake mechanisms.

Since an operational response of such an electric parking brake device is low compared to brake force control devices represented by Anti-lock Brake Systems (ABSs) and Dynamic Stability Control (DSC) systems, when the accelerator pedal is depressed by the driver, the timing for a full release of the wheel brake force by the electric parking brake device is delayed.

Therefore, with the art of JP4725180B, the starting performance of the vehicle may be unintentionally compromised against the wishes of the driver.

Further, with the art of JP41039434B, since the stopped state of the vehicle is maintained by operating the brake force control device, the starting performance of the vehicle may be improved according to the gear position of the gear shift lever.

However, with the art of JP4039434B, due to the structure of the gear shift device of an automatic transmission, even in the absence of the driver's intention to start the vehicle, an automatic brake may still be released while the gear shift lever is being controlled. Thus, depending on road surface conditions, such unexpected vehicle movements may be jarring for the driver.

General gear shift devices of vehicles are provided with gear positions of a drive position (D-range) a neutral position (N-range), a reverse position (R-range), and a parking position (P-range) in this order, and the driver controls the gear shift lever to the position corresponding to an intended shift range.

Therefore, in parking the vehicle, even when the vehicle is automatically braked by the brake force control device, when the driver controls the gear shift lever from the D-range to the P-range, the control toward the R-range is detected via signals when the gear shift lever shifts through the R-range, and the automatic brake is released.

When the automatic brake is released, the vehicle may move due to creep torque even though the driver is not aware of the release. Further, if the vehicle is facing downhill, depending on the gradient (inclination) of the road surface, a downforce caused by the gravity may be larger than the creep torque, and in a worst case scenario, the engine may stall.

### SUMMARY

The present invention is made in view of the above issues, and aims to provide a stop maintaining system of a vehicle, which is capable of obtaining a starting state which matches an intention of a driver, while maintaining the potential advantage of reducing the burden on a driver who depresses a brake pedal.

According to one aspect of the present invention, a vehicle stop maintaining system is provided. The system comprises a foot brake mechanism, a brake force control mechanism, and a controller. The foot brake mechanism is configured to brake vehicle wheels by applying hydraulic brake pressure to hydraulic brake mechanisms according to a depression of a brake pedal. The brake force control mechanism is configured with a pressurizer that increases hydraulic brake pressure that is applied to the hydraulic brake mechanisms, braking the vehicle wheels by controlling the pressurizer independently from the depression of the brake pedal. The controller with a processor is configured to execute, when detecting the vehicle to be in a stopped state, a first stop mode in which the brake force control mechanism is operated to maintain the stopped state. The system further comprises a gear shift lever position detector configured to detect a position of a gear shift lever of the vehicle. When a vehicle driver intentionally controls the gear shift lever to a reverse position in the first stop mode, the controller cancels the first stop mode.

With the above configuration, when the vehicle is detected to be in the stopped state, the controller executes the first stop mode in which the brake force control mechanism is operated to maintain the stopped state. Therefore, a burden on the driver, which accompanies the depression of the brake pedal, is reduced.

Further, the controller cancels the first stop mode when the driver intentionally controls the gear shift lever to the reverse position in the first stop mode. Therefore, it is possible to prevent a situation where the first stop mode is unintentionally cancelled, even when the gear shift lever is shifted through the reverse position as the driver controls the gear shill lever from a drive position to a parking position. Thus, it is possible to obtain a starting state which matches the intention of the driver.

The controller may be further configured to execute a driver intention determiner configured to determine that the driver has an intention of controlling the gear shift lever to the reverse position. When the gear shift lever position detector detects the gear shift lever to be at the reverse position and the controller determines the driver's intention to be to control the near shift lever to the reverse position, the controller may cancel the first stop mode.

According to this configuration, it is possible to reliably determine whether the control of the gear shift lever by the driver toward the reverse position is an intentional control or a transitional control during a switch to the parking position.

The driver intention determiner may determine the driver's intention to be to control the gear shift lever to the reverse position based on a duration of time when the gear shift lever remains at the reverse position.

According to this configuration, it is possible to accurately determine the driver's intention with a simple configuration.

The duration of time when the gear shift lever remains at the reverse position may be 500 to 600 msec.

According to this configuration, it is possible to easily and accurately determine the intention of the driver who controls the gear shift lever to the reverse position.

The system may further comprise a gradient detector configured to detect a gradient state of the vehicle. When the gradient detector detects the gradient state of the vehicle to be one of an uphill gradient, no gradient, and a gentle downhill gradient, the controller may cancel the first stop mode.

According to this configuration, it is possible to obtain a reverse starting state with excellent responsiveness when the vehicle is on an uphill gradient or flat ground.

When the gradient detector detects the gradient state of the vehicle to be the downhill gradient, the controller may prohibit the cancellation of the first stop mode.

According to this configuration, it is possible to prevent an engine from stalling against the driver's wishes when the vehicle is on the downhill gradient.

The system may further include an electric parking brake mechanism configured to brake the vehicle wheels by operating electric brake mechanisms that are driven by electric actuators independently from the depression of the brake pedal, and an ignition state detector configured to detect an ignition state of the vehicle. When the driver controls the gear shift lever to a parking position and tams off an ignition switch in the first stop mode, the controller may cancel the first stop mode and execute a second stop mode in which the stopped state is maintained by operating the electric parking brake mechanism.

According to this configuration, the electric parking brake mechanism is automatically operated, which improves user-friendliness.

### BRIEF DESCRIPTION OF THE DRAWINGS

FIG. 1 is a schematic view of a vehicle on which a stop maintaining system of the vehicle according to one embodiment is mounted.

FIG. 2 is a block diagram of the stop maintaining system.

FIG. 3 is a schematic view illustrating part of a foot brake device, a DSC system, and an EPB (Electric Parking Brake) system.

FIG. 4 is a plan view of a gear shift device.

FIG. 5 is a flowchart of a stop maintaining control process.

FIG. 6 is a flowchart of a gradient control process.

FIG. 7 is a flowchart of a second stop mode control process.

### DETAILED DESCRIPTION OF EMBODIMENT

Hereinafter, an embodiment of the present invention is described in detail with reference to the appended drawings.

The following description is an illustration of the present invention applied to a stop maintaining system of a vehicle, and is not intended to limit the scope of the present invention, application thereof, or usage thereof.

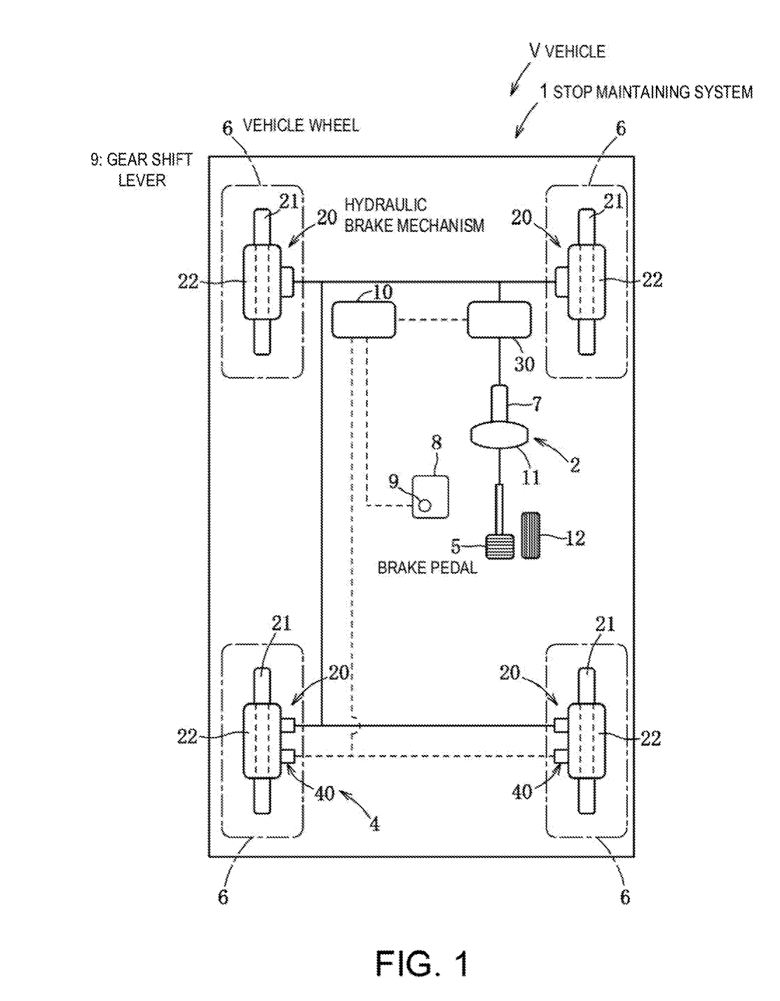

Hereinafter, the embodiment of the present invention is described with reference to FIGS. 1 to 7.

A vehicle V of this embodiment includes an engine of which drive force (speed) is changed by using, an automatic transmission (AT), and an output is transmitted to an output shaft (none of these is illustrated).

The vehicle V is equipped with a stop maintaining system 1.

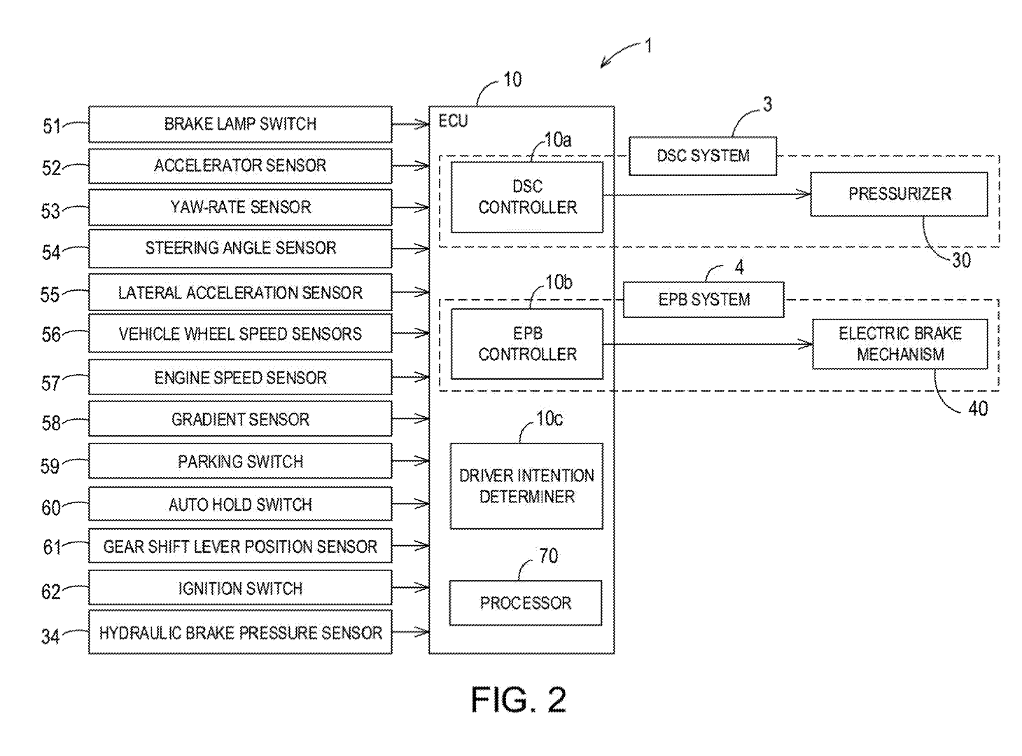

As illustrated in FIGS. 1 and 2, the stop maintaining system 1 includes a foot brake device 2 (foot brake mechanism), a DSC (Dynamic Stability Control) system 3 (brake force control mechanism), an EPB (Electric Parking Brake) system 4 (electric parking brake mechanism), a gear shift device 8, and an ECU (Electronic Control Unit) 10 (Controller).

First, the foot brake device 2 is described.

The foot brake device 2 brakes two front and rear pairs of vehicle wheels 6 by supplying to two front and rear pairs of hydraulic brake mechanisms 20, brake fluid pressurized according to a depression of a brake pedal 5 (hereinafter, referred to as hydraulic brake pressure).

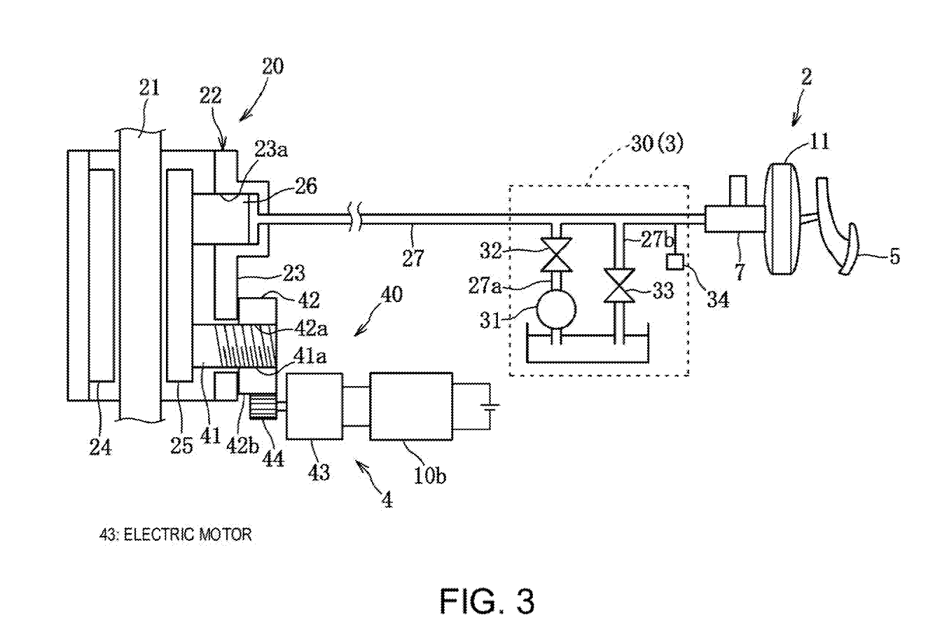

As illustrated in FIGS. 1 and 3, the foot brake device 2 includes the brake pedal 5, a master cylinder 7, a booster 11, and the hydraulic brake mechanisms 20.

The booster 11 has a wall (not illustrated) movable in its axial directions in conjunction with the brake pedal 5, and boosts up the depression force of the brake pedal 5 by using a difference in pressure between a negative pressure chamber and an atmospheric pressure chamber which are divided from each other by the movable wall. The hydraulic brake mechanisms 20 provided to the respective vehicle wheels 6 are connected with the master cylinder 7 by a pipe 27, so as to apply a brake force to the respective vehicle wheels 6 according to the depression of the brake pedal 5 performed by a vehicle driver.

As illustrated in FIG. 3, each hydraulic brake mechanism 20 includes a rotor disk 21 provided with the vehicle wheel 6 to be integrally rotatable, and a caliper 22 for applying the brake force to the rotor disk 21.

The caliper 22 has a caliper body 23 mounted over the rotor disk 21, and an outer brake pad 24 and an inner brake pad 25 which are provided inside the caliper body 23 and interpose the rotor disk 21 therebetween.

A piston 26 is disposed on the inner side of the inner brake pad 25 to be movable in axial directions of the rotor disk 21, and the piston 26 is slidably fitted into a cylinder hole 21a which is formed in the caliper body 23. The cylinder hole 23a is connected to the pipe 27.

When the driver depresses the brake pedal 5, the hydraulic brake pressure is applied to the cylinder hole 23a through the pipe 27, and moves the piston 26 outwardly in the axial directions.

Accordingly, the inner brake pad 25 is pushed against the inner side of the rotor disk 21, and due to a counterforce against this, the caliper body 23 moves inward and the outer brake pad 24 is pushed against the outer side of the rotor disk 21. Thus, the brake force of the foot brake device 2 is produced.

Next, the DSC system 3 is described.

The DSC system 3 brakes the vehicle wheels 6 independently from the depression of the brake pedal 5. The DSC system 3 executes a first stop mode in which the stopped state of the vehicle V is maintained starting when an auto hold execution condition (an auto bold switch 60 is turned on and the vehicle V is in the stopped state) is satisfied, until an auto hold release condition (an accelerator pedal 12 is depressed) is satisfied.

Note that the stopped state of the vehicle V is determined using a determination condition, such as the depression of the brake pedal 5 continuing for over a given duration of time.

As illustrated in FIG. 2, the DSC system 3 is comprised of a DSC controller 10a and a pressurizer 30.

The DSC controller 10a receives input signals from various sensors and executes a DSC control so as to improve travel stability in turning the vehicle V. For example, when a turning state of the vehicle V is determined to be deviated by a given value or above based on detection signals from a yaw-rate sensor 53, a lateral acceleration sensor 55, and vehicle wheel speed sensors 56, the DSC controller 10a controls the brake force on the vehicle wheels 6 by operating the pressurizer 30, so as to orient the turning state of the vehicle V to a target direction by causing a yaw moment to act on a vehicle body.

Further the DSC controller 10a receives the input signals from the various sensors and executes an ABS control so as to prevent the respective vehicle wheels 6 from being locked. For example, when a slip ratio of each vehicle wheel 6 is calculated based on a detection signal of the vehicle wheel speed sensor 56 and a vehicle wheel 6 for which the calculated slip ratio exceeds a given threshold is detected, the DSC controller 10a prevents the locking of this vehicle wheel 6 by controlling the operation of the pressurizer 30 to reduce the brake force which acts on the vehicle wheel 6.

The DSC system 3 has, in addition to the control functions like the DSC control and the ABS control, a brake device function that executes the first stop mode in which the stopped state of the vehicle V is maintained.

As illustrated in FIG. 3, the pressurizer 30 includes a hydraulic pump 31, a pressurizing valve 32, a return valve 33, and a hydraulic brake pressure sensor 34 for detecting hydraulic brake pressure within the pipe 27.

The hydraulic pump 31 is disposed in a first branch path 27a branching from the pipe 27 and is constructed by an electric pump having an electric motor as its drive source. The hydraulic pump 31 receives electric power from an alternator while the engine is in operation, and receives electric power from a vehicle-mounted battery (not illustrated) while the engine is stopped. The hydraulic pump 31 is controlled by the DSC controller 10a.

The pressurizing valve 32 is disposed in the first branch path 27a between the hydraulic pump 31 and the pipe 27, and the return valve 33 is disposed in a second branch path 27b branching from the pipe 27. The valves 32 and 33 are constructed by electromagnetic valves and controlled by the DSC controller 10a.

Next, the EPB system 4 is described.

The EPB system 4 is driven independently from the depression of the brake pedal 5 and executes a second stop mode in which the stopped state of the vehicle V is maintained when a given condition is satisfied.

As illustrated in FIG. 2, the EPB system 4 is comprised of an EPB controller 10b and electric brake mechanisms 40.

The EPB controller 10b receives the input signals from the various sensors and controls the vehicle wheel brake force of the electric brake mechanisms 40. For example, the EPB controller 10b controls the vehicle wheel brake force of the electric brake mechanisms 40 to a given load, based on an ON signal of a parking switch 59 and an execution signal of the second stop mode.

As illustrated in FIG. 3, each electric brake mechanism 40 includes a piston 41, an annular member 42, and an electric motor 43.

A male threaded portion 41a is formed on an inner end portion of the piston 41, and engaged with a female threaded portion 42a formed on a circumferentially inner surface of the annular member 42. A gear surface portion 42b is formed on a circumferentially outer surface of the annular member 42 and engaged with a pinion 44 attached to a drive shall of the electric motor 43 to be integrally rotatable. Therefore, by driving the electric motor 43, the annular member 42 is rotationally driven and the piston 41 is moved to progress/treat in its axial directions.

Next, the gear shift device 8 is described.

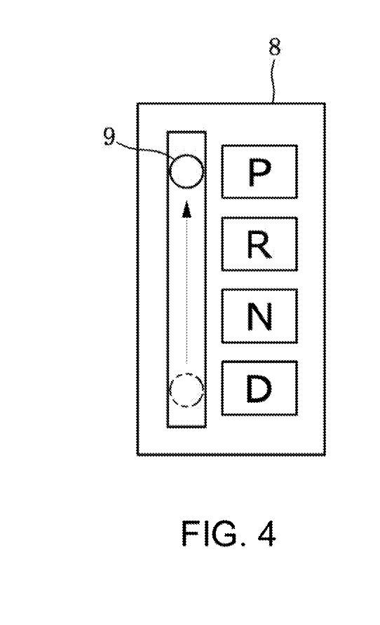

As illustrated in FIG. 4, the gear shift device 8 includes a gear shift lever 9 which the driver is able to control, a shift indicator corresponding to D-, N-, R- and P-ranges which are designed in this order from the bottom side of the drawing, and a gear shift lever position sensor 61 (gear position detector, see FIG. 2) provided inside the device 8.

The gear shift lever position sensor 61 detects gear position corresponding to a gear range selected by the driver based on a relative position of a movable sensor attached to a slider which slides corresponding to a movement of the gear shift lever 9 with respect to a fixed sensor attached to a supporting part (not illustrated) supporting the slider.

Next, the ECU 10 is described.

The ECU 10 is comprised of a processor 70, a ROM, a RAM, an inside interface, and an outside interface. The processor 70 of the ECU 10 is configured to execute various modules of the ECU 10.

The ROM stores various programs and data for stop maintaining control, and the RAM is provided with a processing area for the processor 70 to use when performing a series of processes.

If an engine stop condition (the depression of the brake pedal 5 continues over a given duration of time) is determined as satisfied, the ECU 10 automatically stops (idle stops) the engine. After the automatic stop of the engine, if an engine restart condition the accelerator pedal 12 is depressed) is determined as satisfied, the ECU 10 restarts the engine.

When the auto hold switch 60 is turned on and the vehicle is detected to be in the stopped state, which includes the automatic stop of the engine, the ECU 10 operates the brake device (here, the DSC system 3) to execute the first stoop mode to maintain the stopped state of the vehicle V. When the gear shift lever 9 is in the P-range and an ignition switch 62 which detects the ignition state of the vehicle V is turned off in the first stop mode, the ECU 10 operates the EPB system 4 to maintain the stopped state of the vehicle V and cancels the first stop mode. Further in the first stop mode, the ECU 10 cancels the first stop mode when the driver intentionally controls the gear shift lever 9 to the R-range.

As illustrated in FIG. 2, the ECU 10 is electrically connected to a brake lamp switch 51, an accelerator sensor 52, the yaw-rate sensor 53 a steering angle sensor 54, the lateral acceleration sensor 55, the vehicle wheel speed sensors 56, an engine speed sensor 57, a gradient sensor 58 (gradient state detector), the parking switch 59, the auto hold switch 60, the gear shift lever position sensor 61, the ignition switch 62, the hydraulic brake pressure sensor 34, for example.

The brake lamp switch 51 outputs a detection signal upon detecting the depression of the brake pedal 5 performed by the driver, and the accelerator sensor 52 outputs a detection signal upon detecting a depressed amount of the accelerator pedal 12. The yaw rate sensor 53 outputs a signal corresponding to a yaw rate of the vehicle V, and the steering angle sensor 54 outputs a signal relating to a steering angle of a steering wheel (not illustrated) controlled by the driver. The lateral acceleration sensor 55 outputs a signal relating to an acceleration of the vehicle V in vehicle width directions, and the vehicle wheel speed sensors 56 output signals based on rotational speeds of the vehicle wheels 6, respectively.

The engine speed sensor 57 outputs a signal based on an engine speed, the gradient sensor 58 outputs a signal based on an inclination (gradient state) of a road surface where the vehicle V is stopped, and the hydraulic brake pressure sensor 34 outputs a signal based on hydraulic brake pressure within the pipe 27.

The gear shill lever position sensor 61 outputs a detection signal upon detecting the gear range selected by the driver. The ignition switch 62 outputs a detection signal upon detecting an ON/OFF state thereof.

The parking switch 59 operates the EPB system 4 to stop the vehicle V. The parking switch 59 is turned on/off by the driver. In the ON state, the parking switch 59 constantly outputs an ON signal to the ECU 10, and in the OFF state, the parking switch 59 constantly outputs an OFF signal to the ECU 10. The auto hold switch 60 automatically maintains the stopped state of the vehicle V even when the driver removes his/her foot from the brake pedal 5 while waiting at a traffic light or in a heavy traffic jam. This auto hold switch 60 is turned on/off by the driver. In the ON state, the auto hold switch 60 constantly outputs an ON signal to the ECU 10, and in the OFF state, the auto hold switch 60 constantly outputs an OFF signal to the ECU 10.

As illustrated in FIG. 2, the ECU 10 is integrally provided with the DSC controller 10a, the EPB controller 10b, a driver intention determiner 10c, and the processor 70.

The driver intention determiner 10c executed by the processor 70 determines a control intention of the driver toward the R-range.

The driver intention determiner 10c determines the control intention of the driver toward the R-range based on a duration of time for which the gear shift lever 9 remains within the R-range. For example, when an elapsed time from when the position of the gear shift lever 9 is changed to the R-range is compared with a given time length and if the elapsed time is shorter than the given time length, the control intention is determined as a transitional control during the switch from the D-range to the P-range, and if the elapsed time is the given time length or longer, the control intention is determined as an intentional control to the R-range by the driver.

The given time length is set to be 500 to 600 msec based on a shifting time for a general driver. If the given time length is below 500 msec, the transition during the control may falsely be determined as the intentional control toward the R-range, and if the given time length is above 600 msec, the determination requires excessive time and the drive operation performance may degrade.

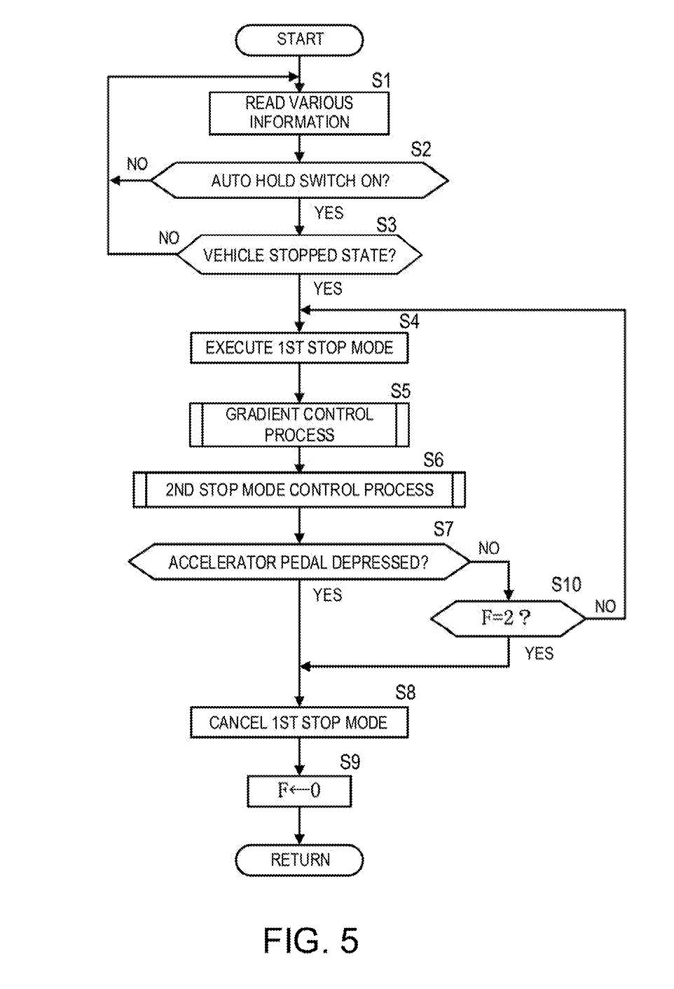

Next, procedures of stop maintaining control process are described based on the flowcharts of FIGS. 5 to 7. Note that in FIGS. 5 to 7, Si (i=1, 2, . . . ) indicates a step for each process.

As indicated in the flowchart of FIG. 5, first in S1, the information, such as the detection values of the respective sensors, is read, and the process proceeds to S2.

At S2, it is determined whether or not the auto hold switch 60 is turned on by the driver.

If the auto hold switch 60 is turned on as a result of the determination of S2, the process proceeds to S3 where it is determined whether or not the vehicle V is in the stopped state. If the auto hold switch 60 is not turned on as a result of the determination of S2, the process returns to the start of the process.

If the vehicle V is in the stopped state as a result of the determination of S3, in order to lower a burden on the driver accompanying the depression of the brake pedal 5 performed by the driver, the process proceeds to 54 where the DSC system 3 executes the first stop mode. If the vehicle V is not in the stopped state as the result of the determination of S3, the process returns to the start.

Since the DSC system 3 executes the first stop mode once the driver depresses the brake pedal 5 and the stopped state of the vehicle V is detected, the driver may release the depression of the brake pedal 5.

In S5, gradient control process is performed and the process proceeds to S6.

The gradient control process described below is performed so as to change the cancel condition of the first stop mode according to the gradient state of the vehicle V.

In S6, the second stop mode control process is executed and the process proceeds to S7.

The second stop mode control process described below is performed so as to change the execute condition of the second stop mode according to the gradient state of the vehicle V.

In S7, it is determined whether or not the accelerator pedal 12 is depressed by the driver.

If the accelerator pedal 12 is depressed as a result of the determination of S7, the hydraulic brake pressure of the DSC system 3 is released to cancel the first stop mode (S8) and the process proceeds to S9.

In S9, a flag F is set to 0 and the process returns to the start.

If the accelerator pedal 12 is not depressed as the result of the determination of S7, the process proceeds to S10 where it is determined whether or not the flag F is 2. As a result of the determination of S10, the process proceeds to S8 if the flag F is 2, and the process returns to S4 if the flag F is not 2.

Thus, the stop maintaining control process is performed.

Next, procedures of the gradient control process are described.

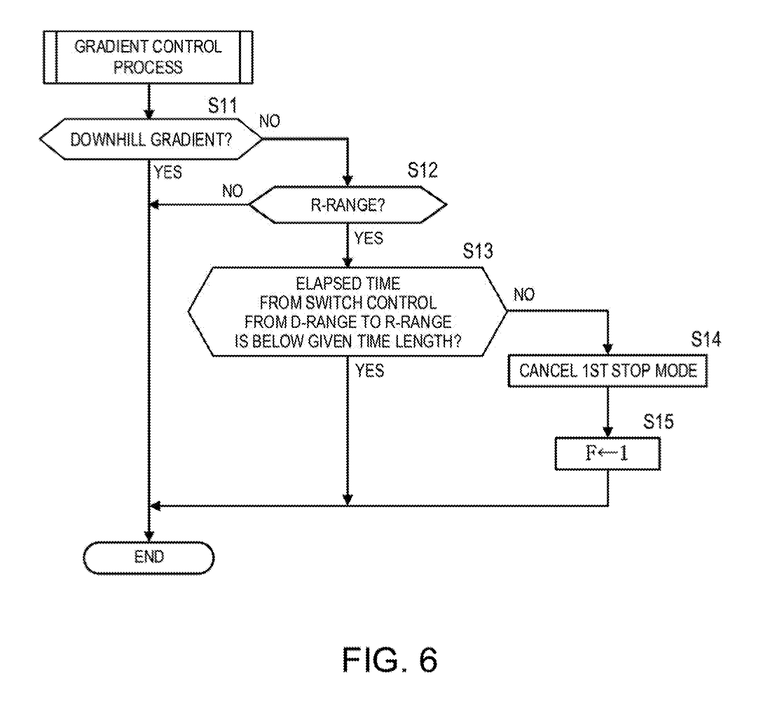

As indicated in the flowchart of FIG. 6, in S11, it is determined whether or not the gradient state is a downhill gradient.

The downhill gradient is determined based on a traveling direction of the vehicle V and the inclination of the road surface.

For example, when the road surface has a given gradient and the vehicle is in a state in which a front part of the vehicle is pointed obliquely downward with respect to a rear part, the gradient of the road surface is determined to be the downhill gradient.

The given gradient is set to be a gradient so that a downforce caused by the gravity which acts on the vehicle V becomes equal to or above a creep torque of the vehicle V on the downhill gradient and within the R-range (6° or above, for example).

If the gradient state is determined to be the downhill gradient as a result of the determination of S11, the process ends.

When the gradient state is the downhill gradient and the downforce caused by the gravity which acts on the vehicle V is equal to or above the creep torque of the vehicle V, if the first stop mode is cancelled, since the vehicle V controlled to the R-mange may stall, the cancellation of the first stop mode is prohibited to prevent the stalling of the vehicle V.

If the gradient state is determined not to be the downhill gradient as the result of the determination of S11, the gradient state is one of an uphill gradient, flat (no gradient), and a gentle downhill gradient. Therefore, the process proceeds to S12 where it is determined whether or not the gear range is the R-range.

If the gear range, is the R-range as a result of the determination of S12, the process proceeds to S13 where it is determined whether or not the elapsed time from the switch control from the D-range to the R-range is below the given time length.

If the gear range is not the R-range as the result of the determination of S12, the process ends.

If the elapsed time from the switch control from the D-range to the R-range is below the given time length as a result of the determination of S13, the process ends.

In other words, if the elapsed time is below the given time length, since the control is determined to be a transitional control during the switch from the D-range to the P-range, the cancellation of the first stop mode is prohibited.

If the elapsed time from the switch control from the D-range to the R-range is the given time length or above as the result of the determination of S13, the process proceeds to S14 where the first stop mode is cancelled.

This is so that a starting state with excellent responsiveness is obtained when the control of the driver is determined to be an intentional control toward the R-range and the gradient is not the downhill gradient.

In S15, the flag F is set to 1 and the process ends.

Thus, the gradient control process is performed.

Next, procedures of the second stop mode control process are described.

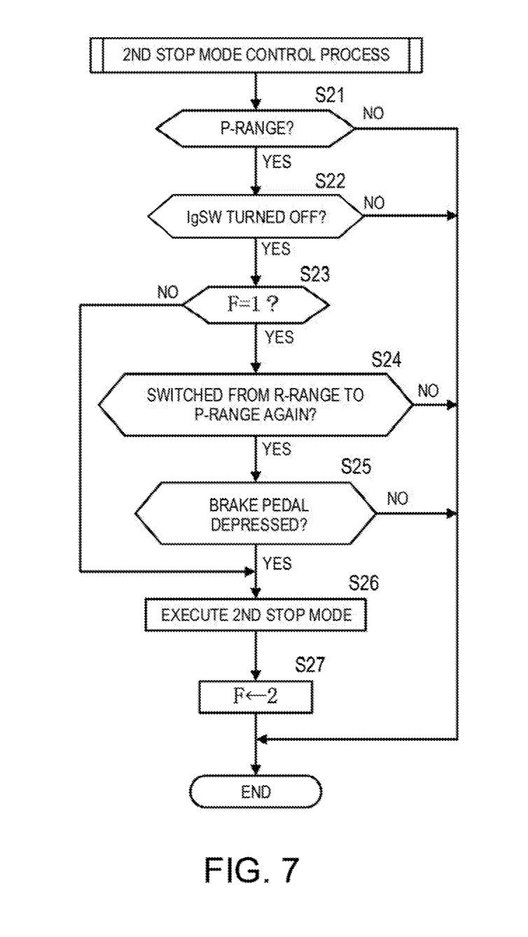

As indicated in the flowchart of FIG. 7, in S21, it is determined whether or not the gear range is the P-range.

If the gear range is the P-range as a result of the determination of S21, the process proceeds to S22 where it is determined whether or not the ignition switch 62 is turned off.

If the ignition switch 62 is turned off as a result of the determination of S22, the process proceeds to S23 where it is determined whether or not the flag F is 1.

If the flag F is 1 as a result of the determination of S23, since the first stop mode is already cancelled, the process proceeds to S24 where it is determined whether or not the gear range is switched from the R-range to the P-range again.

If the gear range is switched from the R-range to the P-range again as a result of the determination of S24, the process proceeds to S25 where it is determined whether or not the brake pedal 5 is depressed by the driver.

If the brake pedal 5 is depressed by the driver as a result of the determination of S25, since the vehicle V is in the stopped state, the process proceeds to S26 where the second stop mode is executed.

In S27, the flag F is set to 2 and the process ends.

If the brake pedal 5 is not depressed by the driver as the result of the determination of S25, or if the gear range is not switched from the R-range to the P-range again as the result of the determination of S24, there is a possibility that the vehicle V is not in the stopped state, and therefore the process ends without executing the second stop mode.

If the flag F is not 1 as the result of the determination of S23, the first stop mode is switched to the second stop mode according to a parking intention of the driver, and therefore the process proceeds to S26.

If the ignition switch 62 is not turned off as the result of the determination of S22, or if the gear range is not the P-range as the result of the determination of S21, the intention of the driver is not to park, and therefore the process ends.

Thus, the second stop mode control process is performed.

Next, operations and effects of the stop maintaining system 1 are described.

According to the stop maintaining system 1 of this embodiment, the first stop mode in which the DSC system 3 is operated to maintain the stopped state is executed when the stopped state of the vehicle V is detected. Thus, it is possible to reduce the burden on the driver due to the depression of the brake pedal 5.

When the driver intentionally controls the gear shift lever 9 to the R-range in the first stop mode, the ECU 10 cancels the first stop mode. Therefore, it is possible to prevent a situation where the first stop mode is cancelled without the driver knowing even if the gear shift lever 9 is shifted through the gear position of the R-range when the driver controls the gear shift lever 9 from the position of the D-range to the position of the P-range. Thus, it is possible to obtain a starting state which matches an intention of the driver.

The driver intention determiner 10c for determining the control intention of the driver toward the R-range is provided, and the ECU 10 cancels the first stop mode when the gear shift lever 9 is detected to be at the gear position of the R-range and the control intention of the driver is toward the reverse position. Therefore, it is possible to reliably determine whether the control of the gear shift lever 9 toward the R-range is the intentional control or the transitional control during the switch from the D-range to the P-range by the driver.

The driver intention determiner 10c determines the control intention of the driver toward the R-range based on the time duration when the gear shift lever 9 remains at the gear position of the R-range. Therefore, it is possible to determine an intentional control to the R-range by the driver with the simple configuration.

The time duration based on which the intention of the driver toward the R-range is reliably determined is 500 to 600 msec. Therefore, it is possible to easily and accurately determine an intentional control to the R-range by the driver.

The gradient sensor 58 for detecting the gradient state of the vehicle V is provided, and the ECU 10 cancels the first stop mode when in the gradient state in which the vehicle V is not on the downhill gradient. Therefore, it is possible to obtain an R-range starting state with excellent responsiveness when the vehicle V is on the uphill gradient or flat (no gradient).

When the vehicle V is on the downhill gradient, the ECU 10 prohibits the cancellation of the first stop mode. Therefore, it is possible to prevent the engine from stalling against the driver's wishes when the vehicle V is on the downhill gradient.

The EPB system 4 which brakes the vehicle wheels by operating the electric brake mechanisms 40 driven by the electric motors 43 independently from the depression of the brake pedal 5, and the ignition switch 62 which detects the ignition state of the vehicle V, are provided. When the driver controls the gear shill lever 9 to the gear position of the P-range in the first stop mode and turns off the ignition switch 62, the ECU 10 cancels the first stop mode and executes the second stop mode in which the stopped state is maintained by operating the EPB system 4. Therefore, the EPB system 4 is automatically operated, which improves user-friendliness.

Next, modifications designed by partially changing the embodiment are described.

(1) The embodiment described above provides the example of providing the DSC controller and the EPB controller integrally with the ECU; however, the DSC system and the EPB system may be configured such that the DSC controller and the EPB controller are provided independently from the ECU, respectively. In this case, the execution commands of the first and second stop modes are outputted to the DSC controller and the EPB controller, respectively.

Further, the pressurizer and the DSC controller may be formed integrally so that the execution command of the first stop mode is directly outputted from the ECU to the pressurizer.

(2) The embodiment described above provides the example in which both of the engine restart condition for after an automatic engine stop, and the auto hold release condition are the execution of depression of the accelerator pedal; however, the conditions may be designed to be one of the release of the brake pedal and the execution of depression of the accelerator pedal.

(3) The embodiment described above provides the example of combining with the automatic stop control (idle stop) of the engine; however, the combination may be with an automatic following control (auto cruise system).

(4) Those skilled in the art may implement a variety of other modes by adding various changes to the embodiment without departing from the scope of the present invention, and such modes fall under the scope of the present invention.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

V Vehicle
1 Stop Maintaining System
2 Foot Brake Device
3 DSC System
4 EPB System
5 Brake Pedal
6 Vehicle Wheel
9 Gear Shift Lever
10 ECU
10c Driver Intention Determining Module
20 Hydraulic Brake Mechanism
30 Pressurizing Unit
40 Electric Brake Mechanism
43 Electric Motor
58 Gradient Sensor
61 Gear Position Sensor
62 Ignition Switch

What is claimed is:

1. A vehicle stop maintaining system comprising:
a foot brake mechanism configured to brake vehicle wheels by applying hydraulic brake pressure to hydraulic brake mechanisms according to a depression of a brake pedal;
a brake force control mechanism configured with a pressurizer that increases hydraulic brake pressure that is applied to the hydraulic brake mechanisms, braking the vehicle wheels by controlling the pressurizer independently from the depression of the brake pedal; and
a controller with a processor configured to execute, when detecting the vehicle to be in a stopped state, a first stop mode in winch the brake force control mechanism is operated to maintain the stopped state,
wherein the system further comprises a gear shift lever position detector configured to detect a position of a gear shift lever of the vehicle; and
wherein when a vehicle driver intentionally controls the gear shift lever to a reverse position in the first stop mode, the controller cancels the first stop mode.

2. The system of claim 1, wherein
the controller is further configured to execute a driver intention determiner configured to determine that the driver has an intention of controlling the gear shift lever to the reverse position,
wherein when the gear shift lever position detector detects the gear shift lever to be at the reverse position and the controller determines the driver's intention to be to control the gear shift lever to the reverse position, the controller cancels the first stop mode.

3. The system of claim 2, wherein the driver intention determiner determines the driver's intention to be to control the gear shift to the reverse position based on a duration of time when the gear shift lever remains at the reverse position.

4. The system of claim 3, wherein the duration of time when the gear shill lever remains at the reverse position is 500 to 600 msec.

5. The system of claim 4, further comprising:
a gradient detector configured to detect a gradient state of the vehicle, wherein
when the gradient detector detects the gradient state of the vehicle to be one of an uphill gradient, no gradient, and a gentle downhill gradient, the controller cancels the first stop mode.

6. The system of claim 5, wherein when the gradient detector detects the gradient state of the vehicle to be the downhill gradient, the controller prohibits the cancellation of the first stop mode.

7. The system of claim 6, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

8. The system of claim 5, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

9. The system of claim 4, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

10. The system of claim 3, further comprising:
a gradient detector configured to detect a gradient state of the vehicle, wherein
when the gradient detector detects the gradient state of the vehicle to be one of an uphill gradient, no gradient, and a gentle downhill gradient, the controller cancels the first stop mode.

11. The system of claim 10, wherein when the gradient detector detects the gradient state of the vehicle to be the downhill gradient, the controller prohibits the cancellation of the first stop mode cancellation

12. The system of claim 11, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

13. The system of claim 10, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

14. The system of claim 3, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

15. The system of claim 2, further comprising:
a gradient detector configured to detect a gradient state of the vehicle, wherein
when the gradient detector detects the gradient state of the vehicle to be one of an uphill gradient, no gradient, and a gentle downhill gradient, the controller cancels the first stop mode.

16. The system of claim 15, wherein when the gradient detector detects the gradient state of the vehicle to be the downhill gradient, the controller prohibits the cancellation of the first stop mode.

17. The system of claim 16, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

18. The system of claim 15, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

19. The system of claim 2, further comprising:
an electric parking brake mechanism configured to brake the vehicle wheels by operating electric brake mechanisms that are driven by electric actuators independently from the depression of the brake pedal; and
an ignition state detector configured to detect an ignition state of the vehicle,
wherein when the driver controls the gear shift lever to a parking position and turns off an ignition switch in the first stop mode, the controller cancels the first stop mode and executes a second stop mode in which the stopped state is maintained by operating the electric parking brake mechanism.

20. The system of claim further comprising:
a gradient detector configured to detect a gradient state of the vehicle, wherein
when the gradient detector detects the gradient state of the vehicle to be one of an uphill gradient, no gradient, and a gentle downhill gradient, the controller cancels the first stop mode.
